(19) United States
(12) Patent Application Publication
(10) Pub. No.: US 2017/0001356 A1
(43) Pub. Date: Jan. 5, 2017

(54) METHOD OF INJECTION MOLDING WITH CONSTANT-VELOCITY FLOW FRONT CONTROL

(71) Applicant: iMFLUX Inc., Cincinnati, OH (US)

(72) Inventors: Herbert Kenneth HANSON, III, CIncinnati, OH (US); Chow-chi HUANG, West Chester, OH (US); Gene Michael ALTONEN, West Chester, OH (US)

(21) Appl. No.: 15/198,556

(22) Filed: Jun. 30, 2016

Related U.S. Application Data
(60) Provisional application No. 62/186,739, filed on Jun. 30, 2015.

(51) Int. Cl. B29C 45/77; B29C 45/78; B29C 45/76; B29C 45/80

(52) U.S. Cl. CPC B29C 45/77; B29C 45/80; B29C 45/78; B29C 45/7646; B29C 2945/76006; B29C 2945/7604; B29C 2945/76287; B29C 2945/76538; B29C 2945/76531; B29C 2945/76498; B29C 2945/76545; B29K 2101/12

(57) ABSTRACT

In order to injection mold parts at a constant flow front velocity in a mold cavity of an injection molding system, particularly where the mold cavity has a varying thickness along its length, mold modeling software is used to calculate the cross-sectional area as a function of the distance from the gate, percentage of fill, or length of the mold cavity. Based on that cross-sectional area, the mold modeling software determines an appropriate recommended ram force profile and/or melt pressure profile that would result in filling the mold cavity at a constant flow rate. An injection molding system is then operated according to the recommended ram force profile and/or melt pressure profile.

### FIELD OF THE INVENTION

This application relates generally to injection molding and, more specifically, to methods for injection molding parts, especially variable-thickness parts, by maintaining a constant flow rate within the mold cavity during the injection molding process.

### BACKGROUND OF THE INVENTION

A useful resource for injection molders is mold modeling software. Mold modeling software can provide output in the form of graphical images of a simulated molded part or portion thereof with, for example, contour lines depicting the progression of one or more flow fronts. Such graphical images can include thermal images to illustrate temperature gradients across and along a part. Output of mold modeling simulations is useful for predicting (and thereby enabling redesign or optimization of a mold or molding component so as to reduce) locations of increased or peak stress, part defects, including short-shots, warpage, excess flashing, flow lines, and sink marks. The output can also be used to determine optimal gate location(s), balancing of runners (particularly among several cavities of a multi-cavity mold), cooling times, and improvements to part design, such as where along a part its thickness can be reduced without unduly compromising part strength or integrity, or where stress concentrations are highest and how those might be mitigated, such as by adding one or more reinforcement ribs to the part.

The output of mold modeling software can provide a wealth of information to mold makers and operators before costly molds are built, as results from the mold modeling simulations can be used to avoid undesirable defects and improve part quality. In addition to serving as an important tool in the design and optimization of molds, data from mold modeling software can be used to improve operation of injection molding systems. For instance, mold modeling simulations can be used to optimize mold cavity wall temperatures, temperatures to which molten thermoplastic material should be heated prior to a shot, the rate at which the molten thermoplastic material should be introduced into the mold cavity, and the pressures to which the molten thermoplastic material should be subjected during an injection molding cycle.

### SUMMARY OF THE INVENTION

When injection molding parts have complicated geometries, such as tapered or stepped regions, the cross-sectional area of the mold cavity typically varies along the length of the part. In an injection molding cycle, this change in cross-sectional area from beginning-of-fill to end-of-fill can have dramatic effects on the flow front of molten thermoplastic material as the mold cavity is filled. For instance, as the flow front of molten thermoplastic material delivered under a given force and pressure reaches a geometric step or change in thickness inside the mold cavity, the flow front can rapidly accelerate or decelerate depending on whether the mold cavity thickness decreases or increases immediately downstream of the step. These sudden variations in flow front velocity adversely affect the non-Newtonian properties of the molten thermoplastic material. The flow front velocity variations can lead to striations or flow lines or cause other optical discontinuities in the molded parts. The non-uniformity in flow front velocity can also lead to localized areas within the mold cavity where thermoplastic material freezes off prematurely, potentially constricting the flow path for further molten thermoplastic material to fill the rest of the part, and dramatically decreasing flow front velocity. Short shots are also commonly attributed to flow restrictions caused by such thickness changes. In addition to adverse aesthetic effects, this can adversely impact the part's structural integrity and drastically increase cycle times. It would be desirable if mold modeling software could be used to determine a set of operating conditions for the ram or screw of an injection molding system that maintains constant velocity of the flow front from beginning-of-fill to end-of-fill, despite changes in cross-sectional area of the mold cavity.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 illustrates a schematic view of a constant pressure injection molding machine constructed according to the disclosure;

FIG. 2 illustrates a front isometric view of an example of a variable-thickness injection molded part;

FIG. 3 is a cross-section of the variable-thickness part of FIG. 2, taken along lines 3-3 of FIG. 2;

FIG. 4 is a schematic illustration of mold cavity thickness of a cavity for injection molding a variable thickness part, with the percentage of fill of the mold cavity increasing from left-to-right in the drawing figure, annotated as the percentage of volume of the overall mold cavity allocated to each distinct geometric region of the part to be molded;

FIG. 5 is a plot of ram velocity against percentage of fill of a mold cavity for an injection molding system operated under conventional parameters, while filling the mold cavity schematically illustrated in FIG. 4;

FIG. 6 is a plot of flow front velocity against percentage of fill, contrasting the degradation in flow front velocity as the flow front approaches the end-of-fill in an injection molding system operated under conventional parameters, with a constant flow front velocity that can be achieved by operating a ram of the injection molding system according to a force profile recommended by a mold modeling simulation using the methodology of the present disclosure;

FIG. 7 illustrates a cross-sectional view of a mold cavity for molding a bar having a constant width and a stepped thickness;

FIG. 8 is a top view of a simulation of the mold cavity illustrated in FIG. 7, generated by mold modeling software, with contour lines representing flow front at uniform time intervals from beginning-of-fill to end-of fill, and the increasing distances between adjacent contour lines depicting increasing flow front velocity;

FIG. 9 is a screen-shot of a mold modeling software display of a graphical image of a simulated mold cavity for molding a bar having a constant width and a stepped thickness such as illustrated in FIGS. 7 and 8, with spaced contour lines depicting a flow front as it progresses through the mold cavity, and the increasing distances between adjacent contour lines depicting increasing flow front velocity;

FIG. 10 is a screen-shot of a graphic user interface and display for mold modeling software including a graphical image of a simulated mold cavity for molding a bar having a constant width and a stepped thickness similar to FIG. 9, and depicting a feature of the mold modeling software that permits the user to select a free surface of the flow front and initiate a request for the mold modeling software to calculate and display at least one of a total cross-sectional area of the selected free surface, and a projected area of the free surface;

FIG. 11 is a screen-shot of a graphic user interface for mold modeling software with features that permit a user to select a desired flow front velocity profile, including a constant flow front velocity, based upon which selection, and other parameters either automatically populated or input by the user, the mold modeling software will calculate a simulated pressure profile to achieve the desired flow front velocity profile;

FIG. 12 is a screen-shot of a graphic user interface and display for mold modeling software with a graphical image of a simulated mold cavity for molding a bar having a constant width and a stepped thickness similar to FIG. 9, each of the substantially uniformly-spaced contour lines depicting a flow front as it progresses through the mold cavity, the contour lines collectively depicting the flow front having a substantially constant flow rate; and

FIG. 13 is a plot of melt pressure against time calculated by the mold modeling software to achieve the constant flow front velocity depicted in FIG. 12.

### DETAILED DESCRIPTION OF THE INVENTION

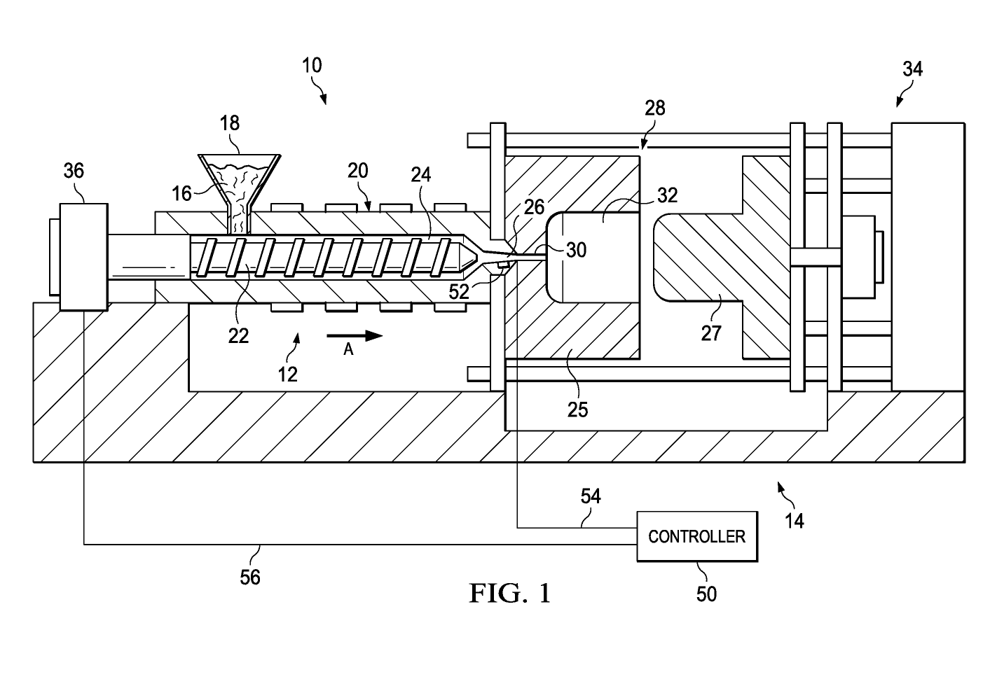

Referring to the figures in detail, FIG. 1 illustrates an exemplary injection molding apparatus 10 for producing thermoplastic parts in high volumes (e.g., a class 101 or 30 injection mold, or an “ultra-high productivity mold”), especially thinwalled parts having an L/T ratio of 100 or greater. The injection molding apparatus 10 generally includes an injection system 12 and a clamping system 14. A thermoplastic material may be introduced to the injection system 12 in the form of thermoplastic pellets 16. The thermoplastic pellets 16 may be placed into a hopper 18, which feeds the thermoplastic pellets 16 into a heated barrel 20 of the injection system 12. The thermoplastic pellets 16, after being fed into the heated barrel 20, may be driven to the end of the heated barrel 20 by a ram, such as a reciprocating screw 22. The heating of the heated barrel 20 and the compression of the thermoplastic pellets 16 by the reciprocating screw 22 causes the thermoplastic pellets 16 to melt, forming a molten thermoplastic material 24. The molten thermoplastic material is typically processed at a temperature of about 130° C. to about 410° C.

The reciprocating screw 22 forces the molten thermoplastic material 24 toward a nozzle 26 to form a shot of thermoplastic material, which will be injected into a mold cavity 32 of a mold 28 via one or more gates. The molten thermoplastic material 24 may be injected through a gate 30, which directs the flow of the molten thermoplastic material 24 to the mold cavity 32. In other embodiments the nozzle 26 may be separated from one or more gates 30 by a feed system (not shown). The mold cavity 32 is formed between first and second mold sides 25, 27 of the mold 28 and the first and second mold sides 25, 27 are held together under pressure by a press or clamping unit 34. The press or clamping unit 34 applies a clamping force during the molding process that is greater than the force exerted by the injection pressure acting to separate the two mold halves 25, 27, thereby holding the first and second mold sides 25, 27 together while the molten thermoplastic material 24 is injected into the mold cavity 32. In a typical high variable pressure injection molding machine, the press typically exerts 30,000 psi or more because the clamping force is directly related to injection pressure. To support these clamping forces, the clamping system 14 may include a mold frame and a mold base.

Once the shot of molten thermoplastic material 24 is injected into the mold cavity 32, the reciprocating screw 22 stops traveling forward. The molten thermoplastic material 24 takes the form of the mold cavity 32 and the molten thermoplastic material 24 cools inside the mold 28 until the thermoplastic material 24 solidifies. Once the thermoplastic material 24 has solidified, the press 34 releases the first and second mold sides 25, 27, the first and second mold sides 25, 27 are separated from one another, and the finished part may be ejected from the mold 28. The mold 28 may include a plurality of mold cavities 32 to increase overall production rates. The shapes of the cavities of the plurality of mold cavities may be identical, similar or different from each other. (The latter may be considered a family of mold cavities).

A controller 50 is communicatively connected with a sensor 52, located in the vicinity of the nozzle 26, and a screw control 36. The controller 50 may include a microprocessor, a memory, and one or more communication links. The controller 50 may also be optionally connected to a sensor 53 located proximate an end of the mold cavity 32. This sensor 53 may provide an indication of when the thermoplastic material is approaching the end of fill in the mold cavity 32. The sensor 53 may sense the presence of thermoplastic material by optically, pneumatically, mechanically or otherwise sensing pressure and/or temperature of the thermoplastic material. When pressure or temperature of the thermoplastic material is measured by the sensor 52, this sensor 52 may send a signal indicative of the pressure or the temperature to the controller 50 to provide a target pressure for the controller 50 to maintain in the mold cavity 32 (or in the nozzle 26) as the fill is completed. This signal may generally be used to control the molding process, such that variations in material viscosity, mold temperatures, melt temperatures, and other variations influencing filling rate, are adjusted by the controller 50. These adjustments may be made immediately during the molding cycle, or corrections can be made in subsequent cycles. Furthermore, several signals may be averaged over a number of cycles and then used to make adjustments to the molding process by the controller 50. The controller 50 may be connected to the sensor 52, and/or the sensor 53, and the screw control 36 via wired connections 54, 56, respectively. In other embodiments, the controller 50 may be connected to the sensors 52, 53 and screw control 56 via a wireless connection, a mechanical connection, a hydraulic connection, a pneumatic connection, or any other type of communication connection known to those having ordinary skill in the art that will allow the controller 50 to communicate with both the sensors 52, 53 and the screw control 36.

In the embodiment of FIG. 1, the sensor 52 is a pressure sensor that measures (directly or indirectly) melt pressure of the molten thermoplastic material 24 in vicinity of the nozzle 26. The sensor 52 generates an electrical signal that is transmitted to the controller 50. The controller 50 then commands the screw control 36 to advance the screw 22 at a rate that maintains a substantially constant melt pressure of the molten thermoplastic material 24 in the nozzle 26. While the sensor 52 may directly measure the melt pressure, the sensor 52 may measure other characteristics of the molten thermoplastic material 24, such as temperature, viscosity, flow rate, etc., that are indicative of melt pressure. Likewise, the sensor 52 need not be located directly in the nozzle 26, but rather the sensor 52 may be located at any location within the injection system 12 or mold 28 that is fluidly connected with the nozzle 26. If the sensor 52 is not located within the nozzle 26, appropriate correction factors may be applied to the measured characteristic to calculate an estimate of the melt pressure in the nozzle 26. The sensor 52 need not be in direct contact with the injected fluid and may alternatively be in dynamic communication with the fluid and able to sense the pressure of the fluid and/or other fluid characteristics. If the sensor 52 is not located within the nozzle 26, appropriate correction factors may be applied to the measured characteristic to calculate the melt pressure in the nozzle 26. In yet other embodiments, the sensor 52 need not be disposed at a location which is fluidly connected with the nozzle. Rather, the sensor could measure clamping force generated by the clamping system 14 at a mold parting line between the first and second mold parts 25, 27. In one aspect the controller 50 may maintain the pressure according to the input from sensor 52. Alternatively, the sensor could measure an electrical power demand by an electric press, which may be used to calculate an estimate of the pressure in the nozzle.

Although an active, closed loop controller 50 is illustrated in FIG. 1, other pressure regulating devices may be used instead of the closed loop controller 50. For example, a pressure regulating valve (not shown) or a pressure relief valve (not shown) may replace the controller 50 to regulate the melt pressure of the molten thermoplastic material 24. More specifically, the pressure regulating valve and pressure relief valve can prevent overpressurization of the mold 28. Another alternative mechanism for preventing overpressurization of the mold 28 is an alarm that is activated when an overpressurization condition is detected.

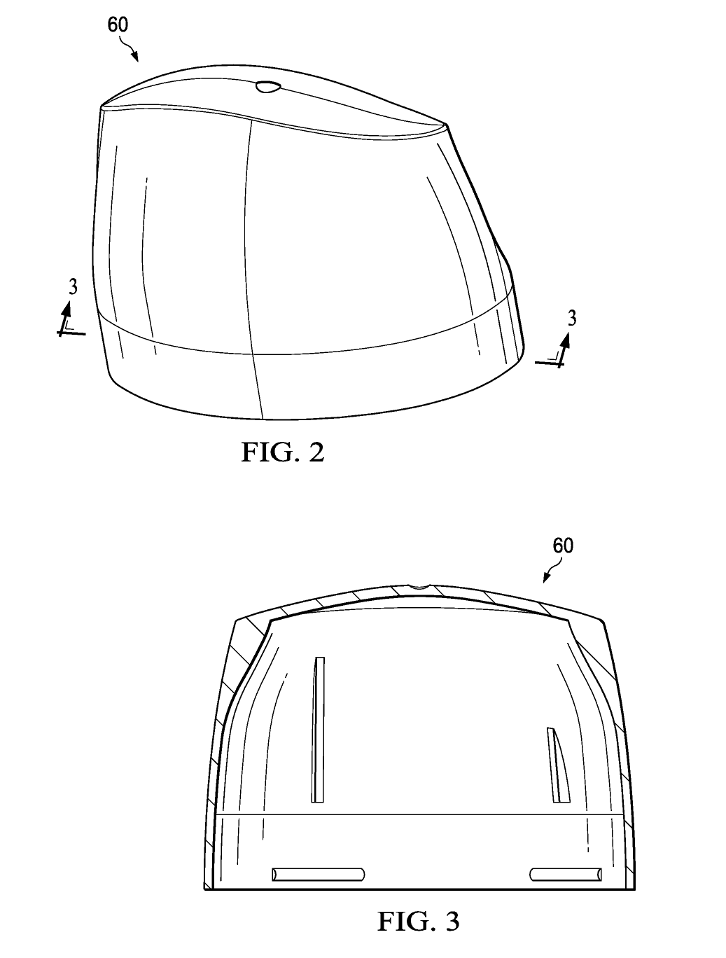

Turning to FIGS. 2 and 3, an injection molded part 60 is illustrated which is, by way of example only, an injection molded cap for a deodorant stick. As can be appreciated from the cross-sectional view of FIG. 3, the injection molded part 60 has a thickness t that varies along its length. Injection molding parts that have variable thickness along their length poses challenges. The geometry of the mold cavities used to produce such parts vary in thickness in a manner that will result in the variable thickness parts. When a flow front reaches a step change in thickness of a mold cavity, the flow rate may increase or decrease. Changes in flow rate can impart visual and/or structural impurities into the molded part.

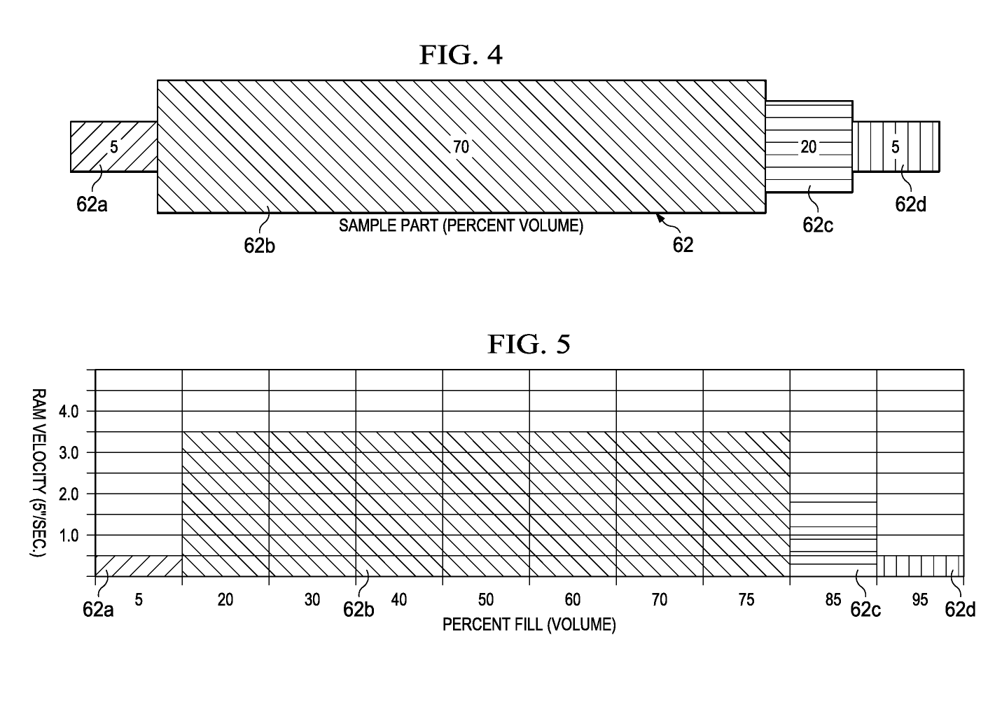

FIG. 4 schematically illustrates a mold cavity 62 for injection molding a variable thickness part. The percentage of fill of the mold cavity 62 increases from left-to-right in the drawing figure, annotated as the percentage of volume of the overall mold cavity allocated to each distinct geometric region of the part to be molded. A first region 62a of the mold cavity has a first thickness and represents 5% of the volume of the resulting part. A second region 62b of the mold cavity has a second thickness and represents 70% of the volume of the resulting part. A third region 62c has a third thickness, which may be less than that of the second region 62b, and represents 20% of the volume of the resulting part. A fourth region 62d has a fourth thickness, which may be less than that of the third region 62c, and represents 5% of the volume of the resulting part.

Turning to FIG. 5, a plot of the velocity of the ram or screw 22 against percentage of fill of the mold cavity 62 is illustrated. The units on the vertical axis of the plot of FIG. 5 are 5 inches per second, so the values on the vertical axis should be multiplied by a factor of 5 to determine the plotted velocities at each percentage of fill increment. The ram velocity increases from 0 to about 2.5 inches per second while filling the first region 62a, levels off to about 17.5 inches per second while filling the second region 62b of the mold cavity, then continually slows down while filling the third and fourth regions 62c, 62d of the mold cavity 62.

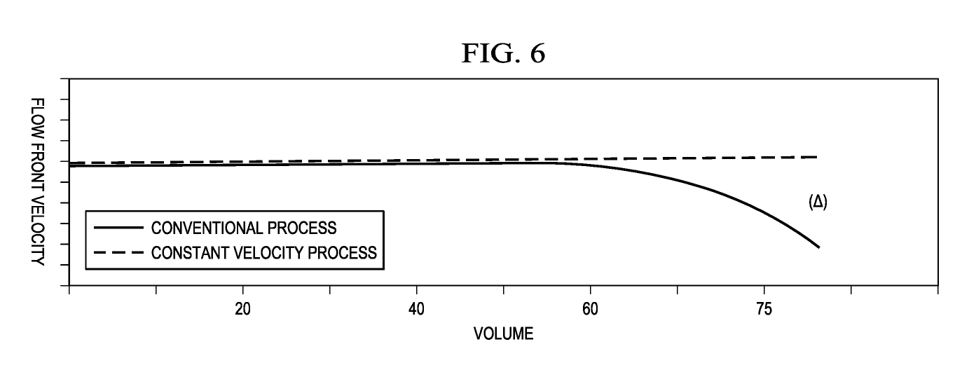

As illustrated in the solid line plotted in FIG. 6, in an injection molding system operated in a conventional manner, the flow front velocity is maintained substantially constant while filling about the first 60% of a mold cavity, then slows down as the molding cycle reaches an end-of-fill state, i.e., a state in which the mold cavity is completely filled.

The visual and structural properties of an injection molded part, and particularly an injection molded part of varying thickness along its length, can be improved by maintaining a substantially constant flow front velocity throughout the entire duration of filling of the mold cavity, as depicted by the dashed line in FIG. 6, regardless of varying thickness along the length of the mold cavity.

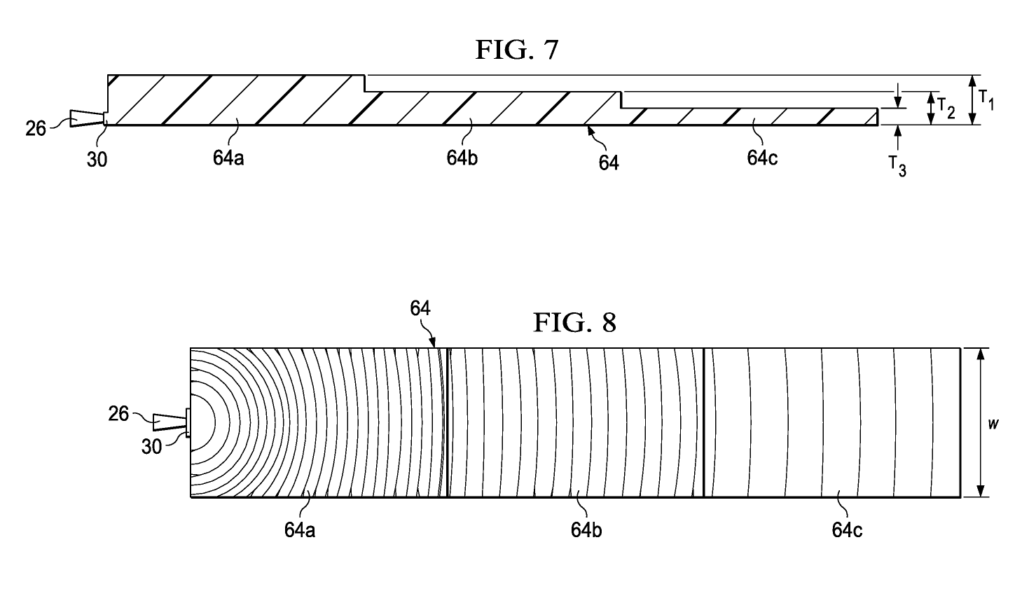

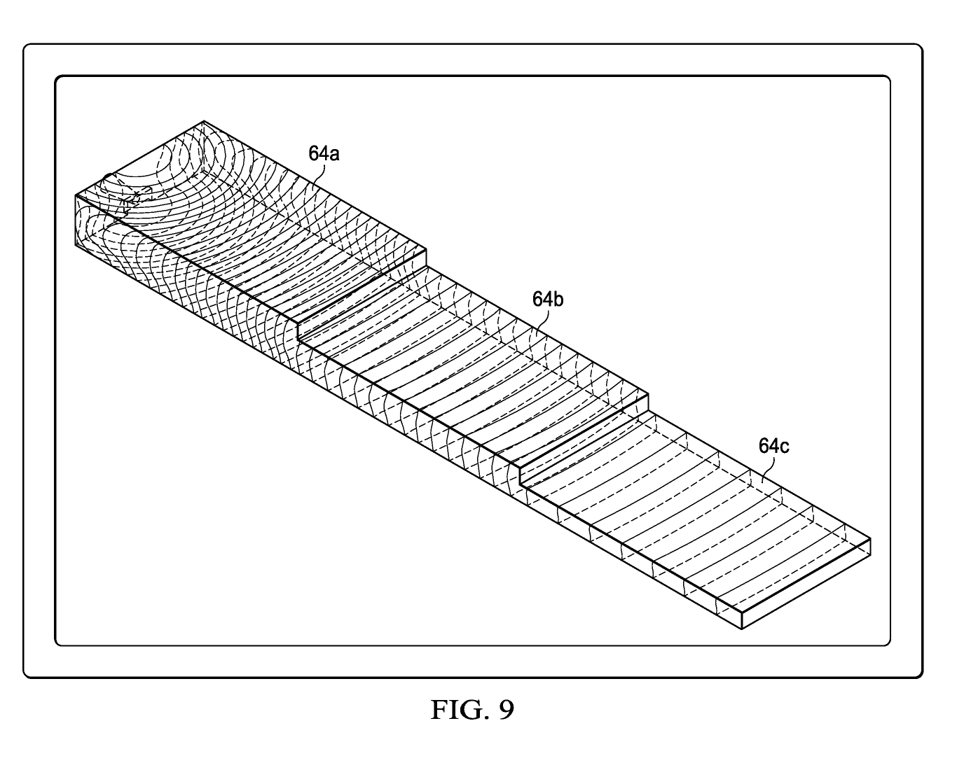

A mold cavity 64 for use in injection molding a bar having a constant width w but a stepped thickness along its length is illustrated in FIG. 7. The nozzle 26 introduces molten thermoplastic material to the mold cavity 64 via the gate 30. The mold cavity 64 includes a first region 64a having a thickness t₁, a second region 64b having a thickness t₂, and a third region 64c having a thickness t₃, with t₁>t₂>t₃.

FIG. 8 is a top view of a simulation of the mold cavity 64 of FIG. 7 generated by mold simulation software. Various mold simulation or mold modeling software exists, such as AUTODESK® MOLDFLOW® ADVISER (TRADEMARK) by AUTODESK, INC., San Rafeal, Calif. The contour lines depict the predicted location of the flow front of a molten thermoplastic material at fixed intervals of time. As would be expected with a mold cavity 64 having a thickness that decreases in a step-wise fashion from beginning-of-fill (i.e., at the location of the gate 30) to end-of-fill (i.e., at an end of the mold cavity 64 furthest from the gate 30), the flow rate of the molten thermoplastic material is higher (faster) while filling the second region 64b than while filling the first region 64a, and still higher (faster) while filling the third region 64c. That the flow rate increases in a manner inversely proportional to the thickness of the respective region of the mold cavity 64 can be appreciated by the increased distance between contour lines in the various regions 64a, 64b, and 64c depicted in FIG. 8. In the depicted example, the thickness of the mold cavity in the first region 64a is three times the thickness of the mold cavity in the third region 64c (t₁=3*t₃), and the thickness of the mold cavity in the second region 64b is twice the thickness of the mold cavity in the third region 64c (t₂=2*t₃). Under such conditions, the average flow front velocity increases in an inverse proportional linear relationship with reduced thickness. Specifically, in the depicted example, average flow front velocity in the second mold cavity region 64b is 3/2 of the average flow front velocity in the first mold cavity region 64a, and the average flow front velocity in the third mold cavity region 64c is three times the average flow front velocity in the first mold cavity region 64a.

FIG. 9 illustrates a graphic user interface for a mold modeling software program, and an orthogonal view of the simulation of the mold cavity 64 of FIG. 8. The contour lines representative of the flow front area at fixed time intervals may be displayed upon the user selecting an option 66 such as the “Flow front area” option under the “Summary—Results—Fit” drop-down menu.

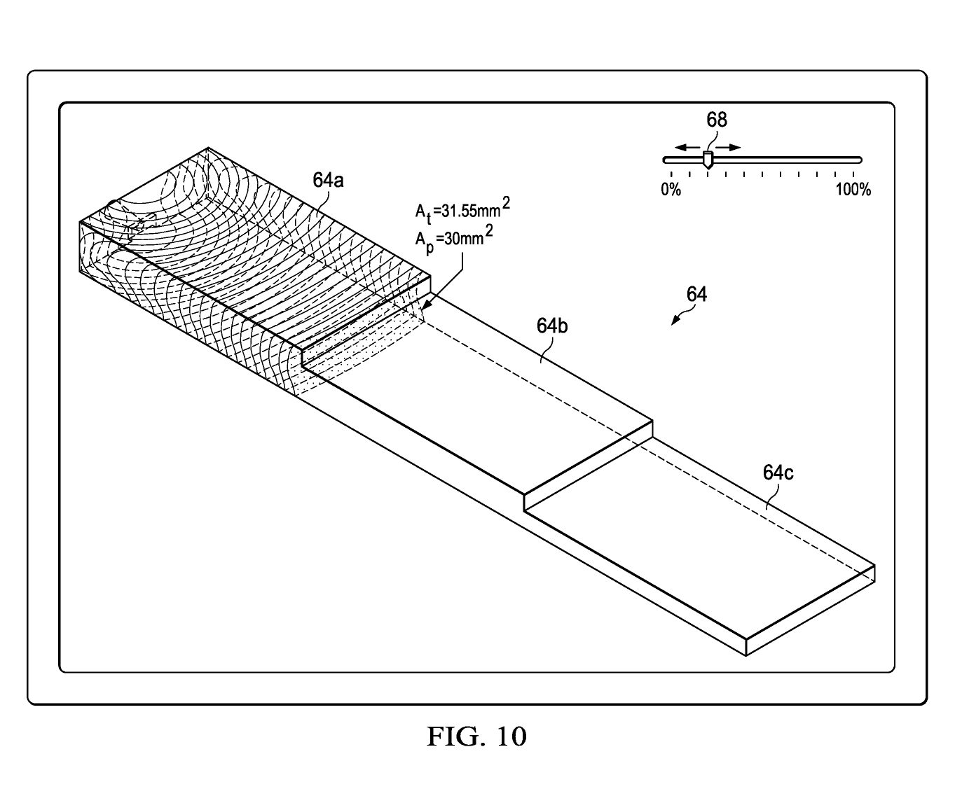

FIG. 10 illustrates how a user interested in a particular point in the analysis, i.e. interested in the conditions within the mold cavity when the flow front has reached a particular point along the length of the mold cavity 64, might manipulate the simulated output of the mold modeling software. For instance, if the user were interested in viewing details at a point during the simulated filling process where the simulated flow front is immediately upstream of a transition from the first mold cavity region 64a to the second, thinner mold cavity region 64b, the user could use a computer input device (not shown), such as a mouse, a touch pad, a stylus, or a touch screen, to drag a slider 68 along an “Animation” line to a location along the line corresponding to the percentage of fill of the mold cavity 64 coinciding with the position of interest. Contour lines depicting the flow front at uniform time intervals from the beginning-of-fill to and including the percentage of fill position corresponding to the selected slider position are then plotted by the mold modeling software. Additional information about that flow front position could then be ascertained using the drop-down menu or by interacting with the graphic representation of the simulated mold cavity in some other fashion, such as by using the computer input device to select one of the illustrated flow front contour lines, then right-clicking or using keystrokes on a keyboard to solicit the mold modeling software to calculate and display at least one of a total area Aₜ and a projected area Aₚ of the flow front at the selected location.

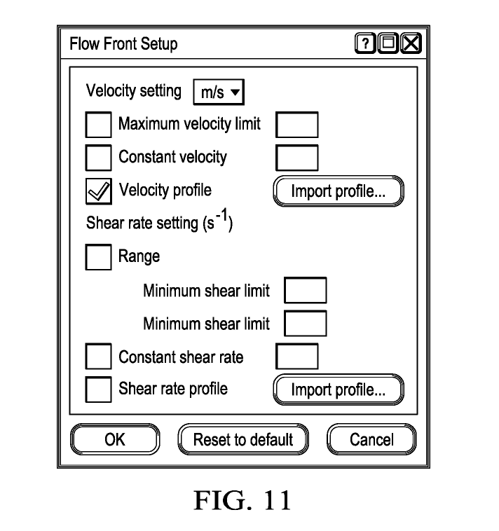

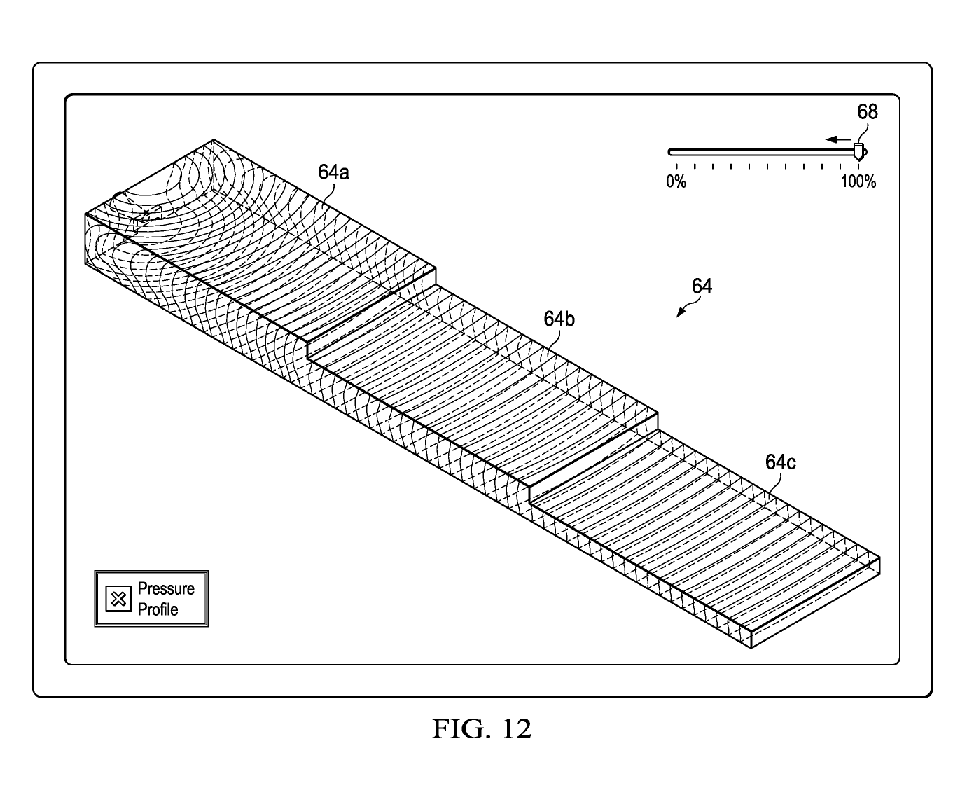

Turning to FIG. 11, a user interface of mold modeling software may provide a user with the ability to select one of a plurality of mold front velocity profiles, such as a “Constant velocity” flow front velocity profile, and generate a pressure profile according to which an injection molding system 10 might be operated to achieve the selected flow front velocity profile. Various parameters that might affect the pressure profile, such as the shear profile of the polymer to be used for the injection molding process, could be input by the user or could be populated based on information stored on a local database which may be provided in a memory on a non-transitory computer readable medium associated with the computer on which the mold modeling software operates. The information might alternately be stored remotely from the computer on which the mold modeling software operates, such as on a server so that stored data remains under the control of the supplier of the polymer, which can then update the data as needed.

As illustrated in FIG. 12, upon selection of the “Constant velocity” mold front velocity profile, and movement of the slider 68 to a position correlating to the end-of-fill of the mold cavity 64, the mold simulation software produces a model of the mold cavity 64 with contour lines at substantially regularly-spaced intervals along the length thereof. As in FIG. 5, each of the contour lines depicts the flow front after a fixed interval of time following the preceding contour line. As such, the substantially uniformly-spaced contour lines depict a substantially constant flow front velocity throughout filling of the mold cavity 64, even as the thickness of the mold cavity 64 reduces from the first mold cavity region 64a to the second mold cavity region 64b, and again from the second mold cavity region 64b to the third mold cavity region 64c.

Of course, the user may, instead of selecting the “Constant velocity” flow front velocity profile, select a different flow front velocity profile. The user may, for example, select a maximum velocity flow front velocity profile (e.g., set a maximum flow front velocity to be achieved) by selecting “Maximum velocity limit” on the user interface shown in FIG. 11. The user may, as another example, import a custom flow front velocity profile by selecting “Flow front velocity profile” and importing such a profile from a local database or a server. Other flow front velocity profiles are also possible. Upon selection of the “Maximum velocity limit” profile, the imported “Flow front velocity” profile, or another profile, the mold simulation software can generate a pressure profile according to which an injection molding system 10 might be operated to achieve the selected flow front velocity profile. More specifically, the mold simulation software produces a model of the mold cavity 64 with contour lines spaced along the length thereof, with the exact spacing depending on the selected profile. The contour lines may, for example, depict a flow front velocity throughout filling of the mold cavity 64 that does not exceed the desired maximum or a flow front velocity that varies throughout filling of the mold cavity 64 based on the custom flow front profile.

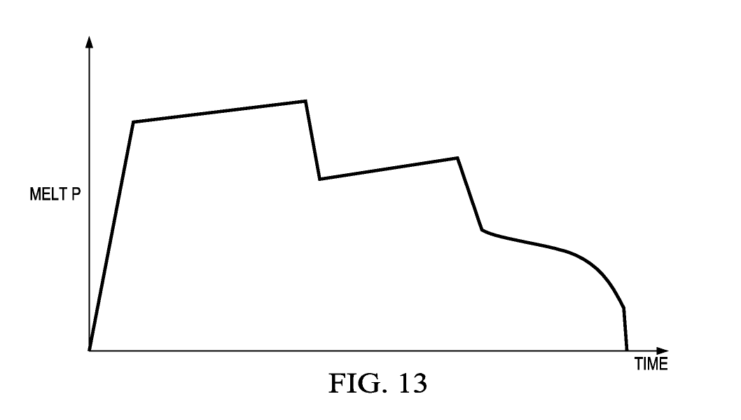

The melt pressure profile recommended by the mold modeling software is plotted in FIG. 13. The manner in which the mold modeling software predicts the appropriate recommended melt pressure profile based on the dimensions of the mold cavity 64 and the selected velocity profile involves determining the cross sectional area of the flow front at each position along the length of the mold cavity 64. The melt pressure profile may then be converted to a ram force profile that directs an operator as to the force profile with which the ram or screw 22 of an injection molding system 10 should be programmed The process of converting the melt pressure profile into the ram force profile may, but need not, take into account a viscosity, a density, a shear temperature, a regrind content, and/or other determined characteristic(s) of the thermoplastic material 24.

The flow front area at each position may be given by the formula:

Flow Front Area(A)=Width (W)*Thickness (T)

or A=WT

Flow Front Velocity (V)=F/A (where F is held constant under conventional process control).

The methodologies described herein may be used to model not only a single mold cavity, but a plurality of mold cavities in a single mold. For instance, the methodologies may be applied to a family mold, wherein the mold cavities vary to different extents along their length, yet the mold modeling software can be employed to predict an appropriate melt pressure versus time profile to achieve an average flow front velocity among all of the mold cavities that is substantially constant.

Based on the foregoing, it is found that a method for injection molding parts, particularly parts having varying thickness along their length, in a manner that minimizes optical and/or structural flaws traditionally associated with injection molding parts using varying flow front velocities includes the following:

Simulating, using a mold flow simulator, an injection molding filling cycle; determining a flow profile including a cross-sectional area of a flow front of a flow of molten thermoplastic material during the simulated injection molding filling cycle; and determining a force profile based at least in part on the determined flow profile, the force profile including a force to be applied to an injection molding ram such that the molten thermoplastic material has a substantially uniform flow front velocity at all times during a filling of one or more mold cavities in an injection molding apparatus operating the injection molding ram according to the determined force profile. Determining the force profile can include determining the force to be applied to the injection molding ram as a function of the cross-sectional area of the flow front. Determining the force profile may alternately include determining the force to be applied to the injection molding ram such that a flow rate of the molten thermoplastic material is proportional to the cross-sectional area of the flow front. In determining the force profile, the cross-sectional area profile can include the cross-sectional area of the flow front of the flow of the molten thermoplastic material as a function of time, a distance from a gate of the mold cavities, or a cavity percent fill of the mold cavities. As discussed herein, the cross-sectional area of the mold cavity or cavities may vary as a function of distance from the gate, or otherwise as the thickness of the mold cavity varies along the length of the mold cavity.

The flow profile may include a first cross-sectional area of the flow front at a first location within the mold cavity, and a second cross-sectional area of the flow front at a second location downstream of the first location, the second cross-sectional area being greater than the first cross-sectional area. Determining the force profile can include determining a first force to be applied to the injection molding ram when it is determined that the flow front is proximate to the first location and a second force to be applied to the injection molding ram for the second cross-sectional area when it is determined that the flow front is proximate to the second location, the second force being larger than the first force. This may involve the use of one or more sensors (e.g., one or more temperature sensors, pressure sensors, ultrasonic sensors, light beams, or other sensors) within or in the immediate vicinity of the mold cavity to determine the location of the flow front at a given time. Alternatively or additionally, the location of the flow front at a given time could be determined based on ram data (e.g., the position of the ram, the speed of the ram), time data (e.g., time elapsed from the initiation of the shot of material 24 into the mold cavity, or time since the flow front reached a given upstream location), or other data.

The force profile may be determined based on at least one of a viscosity, a temperature, a density, and regrind content of the molten thermoplastic material, as well as any fillers, additives, or processing aids of, or employed with, the thermoplastic material.

The method further involves operating an injection molding system according to the force profile recommended by the mold modeling software. The force on the ram would be automatically adjusted by the controller 50 (see FIG. 1) to maintain a desired pressure setpoint following the recommended pressure profile, so as to maintain a constant flow front velocity regardless of the change in thickness along the length of the mold cavity.

In a preferred embodiment, the molten thermoplastic material may be injected at a wherein the injecting comprises maintaining a melt pressure of the shot of the molten thermoplastic material at a substantially constant pressure during filling of substantially each of the mold cavities. A melt pressure of a shot of the molten thermoplastic material may be maintained at a pressure of 50,000 psi or less during filling of substantially each of the mold cavities. Alternately, the melt pressure of the shot of the molten thermoplastic material may be maintained at a pressure of 15,000 psi or less during filling of substantially each of the mold cavities.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method, comprising:
simulating, using a mold flow simulator, an injection molding filling cycle;
determining a flow profile comprising a cross-sectional area of a flow front of a flow of molten thermoplastic material during the simulated injection molding filling cycle; and
determining a force profile based at least in part on the determined flow profile, the force profile comprising a force to be applied to an injection molding ram such that the molten thermoplastic material has a substantially uniform flow front velocity at all times during a filling of one or more mold cavities in an injection molding apparatus operating the injection molding ram according to the determined force profile.

2. The method of claim 1, wherein determining the force profile comprises determining the force to be applied to the injection molding ram as a function of the cross-sectional area of the flow front.

3. The method of claim 1, wherein determining the force profile comprises determining the force to be applied to the injection molding ram such that a flow rate of the molten thermoplastic material is proportional to the cross-sectional area of the flow front.

4. The method of claim 1, wherein the flow profile comprises the cross-sectional area of the flow front of the flow of the molten thermoplastic material as a function of time, a distance from a gate of the mold cavities, or a cavity percent fill of the mold cavities.

5. The method of claim 1, wherein the cross-sectional area varies.

6. The method of claim 1, wherein the flow profile comprises a first cross-sectional area of the flow front at a first location and a second cross-sectional area of the flow front at a second location downstream of the first location, the second cross-sectional area being greater than the first cross-sectional area, and wherein determining the force profile comprises determining the force profile comprising a first force to be applied to the injection molding ram when it is determined that the flow front is proximate to the first location and a second force to be applied to the injection molding ram for the second cross-sectional area when it is determined that the flow front is proximate to the second location, the second force being larger than the first force.

7. The method of claim 1, wherein the flow profile comprises a first cross-sectional area of the flow front at a first location and a second cross-sectional area of the flow front at a second location downstream of the first location, the second cross-sectional area being less than the first cross-sectional area, and wherein determining the force profile comprises determining the force profile comprising a first force to be applied to the injection molding ram when it is determined that the flow front is proximate to the first location and a second force to be applied to the injection molding ram for the second cross-sectional area when it is determined that the flow front is proximate to the second location, the first force being larger than the second force.

8. The method of claim 1, wherein determining the force profile comprises determining at least one of a viscosity, a temperature, a density, regrind content, fillers, additives, and processing aids of the molten thermoplastic material.

9. The method of claim 1, wherein simulating comprises simulating the injection molding cycle for first and second mold cavities in the injection molding apparatus, the first and second mold cavities having different thicknesses, and wherein determining the flow profile comprises determining a first cross-sectional area of the flow front of the flow of molten thermoplastic material into the first mold cavity during the simulated injection molding filling cycle and a second cross-sectional area of the flow front of the flow of molten thermoplastic material into the second mold cavity during the simulated injection molding filling cycle.

10. The method of claim 1, further comprising operating the injection molding ram according to the determined force profile.

11. A method, comprising:
simulating, using a mold flow simulator, an injection molding filling cycle;
determining a flow profile comprising a cross-sectional area of a flow front of a flow of molten thermoplastic material during the simulated injection molding filling cycle;
determining a force profile based at least in part on the determined flow profile, the force profile comprising a force to be applied to an injection molding ram of an injection molding apparatus such that the molten thermoplastic material has a substantially uniform flow front velocity; and
injecting, via the injection molding ram, the molten thermoplastic material into one or more mold cavities of the injection molding apparatus according to the determined force profile.

12. The method of claim 11, further comprising obtaining, during the injecting, using a sensor, data indicative of the molten thermoplastic material flowing at a pre-determined location, and wherein injecting comprises injecting the molten thermoplastic material into the mold cavities based on the determined force profile and the obtained data.

13. The method of claim 12, wherein obtaining comprises detecting at least one of a presence of a flow front, a melt pressure, or a flow rate of the molten thermoplastic material flowing at the pre-determined location.

14. The method of claim 12, wherein the pre-determined location corresponds to a pre-determined time, a pre-determined distance from a gate of the mold cavities, or a pre-determined cavity percent fill of each of the mold cavities.

15. The method of claim 11, wherein the injecting comprises maintaining a melt pressure of the shot of the molten thermoplastic material at a substantially constant pressure during filling of substantially each of the mold cavities.

16. The method of claim 15, wherein the injecting comprises maintaining a melt pressure of the shot of the molten thermoplastic material at a pressure of 50,000 psi or less during filling of substantially each of the mold cavities.

17. The method of claim 16, wherein the injecting comprises maintaining a melt pressure of the shot of the molten thermoplastic material at a pressure of 15,000 psi or less during filling of substantially each of the mold cavities.
